(19) United States
(12) Patent Application Publication
(10) Pub. No.: US 2025/0376741 A1
(43) Pub. Date: Dec. 11, 2025

(54) METHOD OF UPGRADING INDUSTRIAL FURNACE BY-PRODUCTS

(71) Applicant: Magsort Oy, Espoo (FI)

(72) Inventors: Sami LIPONKOSKI, Espoo (FI); Niklas TÖRNKVIST, Espoo (FI); Iva TSENOVA, Espoo (FI)

(21) Appl. No.: 18/877,975

(22) PCT Filed: Jun. 20, 2023
(86) PCT No.: PCT/FI2023/050369

§ 371 Date: Dec. 20, 2024

(30) Foreign Application Priority Data
Jun. 20, 2022 (FI) 20225556

(51) Int. Cl. C22B 7/04; B03C 1/02; C04B 7/28; C04B 7/52; C21B 3/04; C22B 7/00

(52) U.S. Cl. CPC C22B 7/04; B03C 1/02; C04B 7/28; C04B 7/527; C21B 3/04; C22B 7/005

(57) ABSTRACT

Provided herein is a method of treating and upgrading industrial furnace by-products, such as steelmaking slag and incinerator bottom ash (IBA) into valuable products, the method comprising the steps (a) providing the industrial furnace by-product, (b) subjecting the industrial furnace by-product to separation crushing to obtain crushed industrial furnace by-products, (c) subjecting the crushed industrial furnace by-products to one or more magnetic separation step(s) to separate magnetic and non-magnetic particles, and (d) optionally subjecting said non-magnetic particles to fine grinding to obtain fine grinded particles. The fine grinded particles can then be used to produce cement clinkers in kiln.

### FIELD OF THE INVENTION

The present invention relates to a method of processing industrial furnace by-product. In particular, the present invention relates to upgrading steelmaking slag and incinerator bottom ash (IBA), and to a method of separating metals from steelmaking slag and IBA for a more economical way of processing industrial furnace by-product into raw materials for cement and cement clinker.

### BACKGROUND OF THE INVENTION

Steelmaking slag is one of the major by-products in steel, stainless-steel and carbon steel production. It is essential to find uses for all various by-products of industrial processes, including steelmaking slag. It has found uses as filler material in various applications such as coarse aggregates for asphalt, aggregate in concrete production and in making slag phosphate fertilizers. However, new economical methods for upgrading steelmaking slag into valuable products are needed to harness the potential of this industrial by-product.

The slag that originates from steel, stainless-steel and carbon steel production, also called steelmaking slag, is a cementitious material by itself, containing Ca silicates, Ca aluminates and Ca ferrites, and it is a source for free lime.

Another slag, the slag that originates from iron production called blast furnace slag (BFS), is generally known as a beneficial industrial by-product that is widely used in cement industry. Over 70% or the blast furnace slag is ground granulated and used in slag cements. However, steelmaking slag originating from Basic oxygen process or Electric Arc process is not used in cement applications as cementitious material but as a filler.

Incinerator bottom ash (IBA) is a side product formed in incinerator facilities, often discharged from municipal solid waste incinerators. Once removed from contaminants it can be used as filler or aggregate in various applications.

The mineral composition of those industrial by-products is crystalline, and it contains various amounts of valuable metallic steel and other metallic particles. The crystallinity of the minerals combined with the hard metal particles in the by-products make grinding of the by-products difficult and energy consuming, which has previously limited the viability of upgrading industrial furnace by-products. Grinding of the by-products should be done to adequate fineness to gain a positive effect on strength development of the cement while maintaining economical energy consumption.

U.S. Pat. No. 5,421,880 describes a method for manufacturing cement clinkers from steel slag, wherein steel slag is melted and defused into a feedstock material containing lime in a kiln to form cement clinkers. U.S. Pat. No. 4,124,404A describes a method for making steel slag cement by subjecting the slag to reductive treatment and oxidizing and pulverizing the steel slag.

Industrial furnace by-products are today produced in vast amounts. Therefore, there is a need to develop a more viable method for upgrading steelmaking those by products to valuable products that are produced in high volumes. One example is raw materials for cement.

### BRIEF DESCRIPTION OF THE INVENTION

An object of the present invention is thus to provide a method so as to solve the above problems. The objects of the invention are achieved by a method which are characterized by what is stated in the independent claims. The preferred embodiments of the invention are disclosed in the dependent claims.

The current invention thereby provides a method of upgrading industrial furnace by-product, wherein the method comprises:
(a) providing steelmaking slag,
(b) subjecting the industrial furnace by-product to separation crushing to obtain crushed industrial furnace by-product,
(c) subjecting the crushed industrial furnace by-product to at least one magnetic separation step to separate magnetic particles and non-magnetic particles, and collecting said non-magnetic particles,
(d) optionally subjecting said collected non-magnetic particles to fine grinding to obtain fine grinded particles.

The resulting fine grinded non-magnetic particles can then be used as a feedstock material in cement kilns to produce cement clinkers.

General benefits of the method are as follows; use of industrial furnace by-products in valuable products, reduced energy consumption in kiln due to high degree of calcination of the by-products in comparison to limestone, and improved quality of cement and lesser hazardous emissions such as NOx due to lower heat consumption of the process. Industrial furnace by-products can also be used as iron corrective material in clinker production.

### BRIEF DESCRIPTION OF THE DRAWINGS

In the following the invention will be described in greater detail by means of preferred embodiments with reference to the accompanying drawings, in which

FIG. 1 depicts one possible embodiment of the current method.

FIG. 2 depicts one possible embodiment of the current method.

FIG. 3 depicts the results of a particle size distribution test performed on steel slag that has been subjected to high impact crushing.

### DETAILED DESCRIPTION OF THE INVENTION

Traditional cement making is responsible for about 8% of global CO₂ emissions. When limestone (CaCO₃) is heated in a cement kiln, desired CaO is obtained, but a large amount of CO₂ is released as a side product. industrial furnace by-products contain large amounts of CaO and SiO₂, which are compounds needed in cement making. In addition, it brings to the mix valuable iron oxides remaining after magnetic separation.

In the present invention, industrial furnace by-products are used instead of limestone-clay, to reduce CO₂ emissions caused by the cement making process. Traditionally, when making cement clinkers in cement kilns, limestone-clay mix is calcinated in the kiln, which releases CO₂. Industrial furnace by-products, for example, steelmaking slag and IBA are materials that have already been calcinated, which means that no new CO₂ is released in the kiln. Thus, using industrial furnace by-products to produce cement clinkers reduces CO₂ emissions in comparison to using limestone.

Using industrial furnace by-products instead of limestone-clay mix in the production of cement clinkers has the additional benefit of reduced energy consumption. For example, steel slag contains belite which is converted into alite in an exothermic reaction in the cement kiln. On the other hand, calcination of limestone inside the kiln is an endothermic reaction that consumes energy.

An object of the current invention is to present a method for upgrading industrial furnace by-products into raw materials that can be used as a substitute for low CO₂ cement. Presented here therefore is a method for treating industrial furnace by-products. The method comprises providing industrial furnace by-product, subjecting the industrial furnace by-product to separation crushing to obtain crushed industrial furnace by-product, wherein metals and minerals have been separated from each other. Base for the invention is that a crushing step involves the separation of small 0-2 mm metal particles from the mineral matrix of the slag. These small metal particles are referred to as hard grinding substance and prevent an economical way of grinding the resulting mineral fraction. The crushed industrial furnace by-product is subjected to magnetic separation to separate magnetic particles and non-magnetic particles, after which the non-magnetic particles are optionally collected to obtain non-magnetic mineral fraction. This non-magnetic mineral fraction is then optionally subjected to one or more fine grinding step(s), wherein the non-magnetic mineral fraction is grinded into fine powder with particle diameter of 10 μm to 100 μm, preferably from 20 μm to 70 μm.

This fine powder can then be used as raw materials in a cement kiln.

Here, the term “industrial furnace by-products” or “by-products” for short refer to any by-product formed in an industrial process involving high temperatures or incineration. The industrial furnace by-product can, for example, be steelmaking slag or incinerator bottom ash (IBA). The term “steelmaking slag” here refers to any solid waste or by-product formed in the production of steel, stainless-steel or carbon steel. Steelmaking slag can be, but is not limited to, steel slag, stainless steel slag, carbon-steel slag, basic oxygen furnace (BOF) slag, electric arc furnace (EAF) slag or ladle furnace (LF) slag.

Incinerator bottom ash is the by-product produced in waste incineration or other high temperature incineration process.

For example, stainless-steel slag can typically contain up to 4 to 5 wt % metallic stainless-steel, which is a valuable product, but which also increases the energy consumption of the fine grinding steps if it is left in the crushed slag. The rest of the slag, which will from now on be referred to as the mineral fraction, comprises various calcium, silica, iron, and chromium oxides. IBA on the other hand contains 2 to 15 wt % total of very valuable, heavy non-magnetic metals such as copper.

A typical mineral fraction of steelmaking slag can have the following composition (in wt-%):

| | |
|---|---|
| SiO₂ | 10-50% |
| Fe₂O₃ | 3-35% |
| Cr₂O₃ | 4% |
| MnO | 5% |
| CaO | 15-45% |
| MgO | 1-15% |
| Al₂O₃ | 1-8% |
| SO₃ | 2%. |

The industrial furnace by-product, which can be, for example, steelmaking slag or IBA, is first subjected to separation crushing to obtain crushed industrial furnace by-product. Herein the term “separation crushing” means a method, wherein the slag is crushed, i.e., to produce smaller particle size of a solid material, and the crushing is done with a method that separates metallic metals and the minerals in the by-product from each other. The separated minerals can contain metals in compound form, for example as calcium silicate, calcium ferrite and brownmillerite. One example of separation crushing method is high impact dry crushing according to patent publication FI128329.

Hereby with high impact crushing is meant any crushing, where the material to be crushed is forced in one direction and hit with a rotor or something similar moving in the opposite direction to the material to be crushed, thereby resulting in the crushing of the material. The kinematic energy is thereby quad- rupled when the relative velocity of the material to be crushed is doubled at the impact.

High impact dry crushing can be performed with a mill which consists of casing, cover and bottom, and inside said mill is a crusher capable of crushing industrial furnace by-products. This crusher consists of two rotors rotating in opposite directions: an inner rotor and an outer rotor. The material to be crushed, i.e., industrial furnace by-product is fed into the middle of the inner rotor. As a result of the centrifugal forces which result from the rotation of the inner rotor, the material to be crushed is ejected to the outer rotor, and as a result the material is crushed due to the high impact. The material is then removed through removal holes at the bottom of the mill. Optionally the mill can further include an air gap between the rotation axis of the outer rotor and the feed pipe, through which compressed air can be supplied in between the rotors.

The well-known physical equation shows that E=½mv². According to the equation, if the velocity of the material is doubled, the energy quadruples. In the high impact dry crushing equipment described above, the equipment has two rotors rotating in opposite directions. When the material ejected from the inner rotor hits the outer rotor the relative speed of the material is doubled which then quadruples the energy of the impact. This enables efficient crushing of the industrial furnace by-product.

In one embodiment, the separation crush is performed with a dry crushing method. In this case, dry crush here means that essentially no water or other liquid is added to the slag before the crushing. Traditionally metallic stainless-steel is separated from steelmaking slag through wet grinding which requires adding water or other liquid to the slag before crushing it. As a result of wet grinding, the remaining slag is turned into a wet slurry, which cannot be recycled. A dry crushing method prevents the formation of slurry and enables the use of the mineral fraction in cement.

While it is preferable to use a dry crushing method, such as high impact dry crush, the by-products can contain a certain amount of moisture depending on the production of the steel and/or stainless steel as well as the pretreatment of the by-product. In one embodiment of the invention the slag which is subjected to the dry crushing has a moisture content from 2 wt. % to 15 wt. %, preferably from 3 wt. % to 8 wt. %.

The separation crushing of the industrial furnace by-product can be performed with any suitable method which separates metals and minerals, including but not limited to milling, grinding, using a vertical or horizontal shaft impact crusher, a rotor centrifugal crusher or any combination thereof. The separation crushing of the current invention can be performed in one or more than one step.

In one embodiment the separation crushing of the by-product is performed in two stages, of which the first dry crushing stage provides coarser particles, which are subjected to a second stage dry crushing, which provides the separated finer particle sizes.

In one embodiment of the invention, the separation crushing is performed in more than two stages, in which each subsequent stage provides more finer particles compared to the previous stage. The milling can be performed in at least two stages, of which each can further constitute one or more individual crushing steps.

In one embodiment the separation crushing of the industrial furnace by-product is performed in one or more stages using mills according to patent publication FI128329. The size and capacities of the mills or crushers used in the separation crushing step depend on the amount of slag to be treated. The number of crunchers or crushers and/or crushing stages can depend on the type of by-product and the wanted distribution of particles based on size. A person of ordinary skills in the art is capable of designing and choosing the size and capacity of the equipment and how many crushing stages are required to obtain the desired particles with desired particle sizes for further processing.

The separation crushing step can optionally be followed by one or more classification step(s) followed by one or more separation step(s). The crushed industrial furnace by-product can be separated into different fractions according to particle size.

In one embodiment at least one fine particle fraction consisting of particles with particle size of less than or equal to 3 mm, preferably less than or equal to 2.5 mm is obtained.

In one embodiment, the particle fractions with particle size of more than 3 mm are recycled back for another dry crushing step.

In one embodiment of the current invention the optional classification step(s) and separation step(s) are performed according to the following disclosure.

The industrial furnace by-product that has been crushed in the separation crushing step is classified based on the size of the particles. The classification of the crushed by-product particles can be performed using any suitable method for sieving or screening the formed particles. The classification or separation based on particle size is done to obtain at least two fractions with different particle sizes. The two fractions can be characterised as small fraction and middle fraction.

In one embodiment a large fraction is separated, which can be recycled back to the dry crushing stage.

It is to be understood that the by-product can be classified into fractions after crushing. The number of specific fractions and the size-distribution of the particles in various sub-fraction is not important for carrying out the invention. The number of fractions and size-distribution of the particles within the fractions can be designed and planned based on the amount of by-product and the capacities of the separation techniques chosen to carry out the invention.

The crushed industrial furnace by-product is subjected to a magnetic separation. Magnetic separation step can be performed before or after classification step(s). If the magnetic separation step is preceded by classification and separation step(s), the obtained fractions are subjected to the magnetic separation as individual fractions, i.e., the fractions with different particle size particles are not mixed before the subsequent separation steps. For the magnetic separation any suitable magnetic separation technique can be applied.

In one embodiment, the crushed by-product is subjected to a non-magnetic metal separation step(s). The non-magnetic separation method can be selected from a list comprising eddy-current separation, gravitational separation, airflow separation and any combination thereof, to separate heavy and light non-magnetic metals. Non-magnetic separation step can be performed on any kind of industrial furnace by-product, but it is particularly beneficial if the treated industrial furnace by-product is IBA.

If the treated industrial furnace by-product is IBA, some hard, non-magnetic metal particles may remain in the crushed IBA even after magnetic separation step. These metal particles can in some cases make the optional fine grinding step difficult or impossible to perform. However, these metal particles can be separated from the crushed industrial furnace by-products with non-magnetic separation using the methods described above.

Non-magnetic metal separation step can be performed before or after the optional classification step(s), but after separation crushing.

If the magnetic separation step is preceded by classification and separation steps(s), the obtained fractions are subjected to the magnetic separation as individual fractions, i.e., the fractions with different particle sizes are not mixed before the subsequent separation steps. For the magnetic separation any suitable magnetic separation technique can be applied.

In one embodiment of the invention the magnetic separation is performed in two stages or more.

In one embodiment, the two stages of the magnetic separation is performed by a first magnetic separation using a strong magnet followed by a second magnetic separation using a weak magnet.

In one embodiment, the weak magnetic separation is performed before the strong magnetic separation.

In one embodiment, a combination of two strong magnetic separations is applied.

In one embodiment, the strong magnetic separation is performed using a rare earth magnet, an electromagnet or other type of strong magnet.

According to the invention the classification and separation steps are chosen such that at least one fine particle fraction contains particles with a particle size of 3 mm or less, preferably 2.5 mm or less.

The fine particle fraction containing particles with particle size of 3 mm or less is subjected to a magnetic separation such that magnetic particles are separated from non-magnetic particles. The fine non-magnetic particles are collected. The magnetic particles can also be collected. The magnetic particles contain a high amount of steel and can thus be used as a raw material to obtain steel.

After magnetic separation, the collected non-magnetic particles are optionally subjected to further fine grinding obtaining fine grinded non-magnetic particles. The particle size of the fine grinded non-magnetic particles can be from 10 μm to 100 μm, preferably from 20 μm to 70 μm.

In one embodiment, the fine grinding step is performed in a way that ensures that the collected fine non-magnetic minerals containing calcium, silicate, iron, and alumina are separated from each other.

In one embodiment of the invention, fine grinding is performed using friction grinding. Friction grinding causes local temperature changes which lead to change of crystalline mineral phase into amorphous phase, which increases the cementitious activity of the mineral fraction.

In one embodiment of the invention the method further comprises subjecting, the collected non-magnetic particles directly after separation or after further fine grinding step d), wherein fine grinded particles are obtained, to a cement kiln for manufacturing cement clinkers. This is typically performed as a co-processing in a normal cement kiln as an additional feed to the cement kiln.

In one embodiment, the collected non-magnetic particles or the fine grinded particles are used as the only raw material of the feed.

In one embodiment, they are used as a part of a feed with other raw materials.

In one embodiment, one or more additional ingredients selected from the list consisting of limestone, gypsum, clay, shale, sand, iron ore, bauxite, fly ash, blast furnace (BF) slag are added to the cement kiln feed.

The collected fine non-magnetic particles contain mainly CaO and Si₂O, which is an excellent starting material for production of cement. The cement raw materials are put into a rotating cement kiln that is heated in stages to up to 1500° C. During this process, the raw materials are converted into typical cement compounds, for example dicalcium silicate (2CaO·SiO₂) and tricalcium silicate (3CaO·SiO₂), tricalcium aluminate (3CaO·Al₂O₃) and tetracalcium-aluminoferrite (4CaO·Al₂O₃·Fe₂O₃).

Usually, industrial furnace by-product, especially steelmaking slag, contains remains of metals, such as Fe, Cr and V. The high temperatures in a cement kiln may lead to conversion of Cr and V into hexavalent Cr and VN, which are both hazardous compounds. The method according to the invention includes a magnetic separation step that reduces the amount of metallic particles in the industrial furnace by-product. This leads to reduced formation of hazardous components, which improves the quality of the cement. In addition, smaller amount of metallic particles lessens the amount of energy used in the fine grinding step of the method, which in turn makes the process more economical.

Usually, when excess of Cr⁶⁺ is found in the clinker, ferrous or tin sulphates are used to correct it cement. Magnetic separation used in the present invention reduces the overall level of Cr in the slag, which means that less Cr⁶⁺ reducing agent is needed.

The fine non-magnetic particles obtained by the current method contain a decreased amount of metals, such as Fe, Cr, V due to the magnetic separation. This is beneficial since the fine grinding requires less energy. More importantly, this is beneficial since these metals, especially Cr and V are not wanted in cement. Therefore, the magnetic separation prior to collecting the fine particles enables a material/fraction which is better suited as feed for cement kiln.

In one embodiment, the collected non-magnetic particles are subjected to at least one fine grinding step together with at least one other material to form a fine grinded raw mix. The fine grinded raw mix is then subjected to a cement kiln to make cement clinkers.

In one embodiment, the collected non-magnetic particles are subjected to at least one fine grinding step to obtain fine grinded particles. The fine grinded particles are then subjected to a cement kiln to make cement clinkers. It is advantageous that fine particles obtained in separate grinding step can be fed to kiln either together with other raw material(s) or in a later stage of kiln production. As the slag is a calcined material it can be fed after the pre-calcination zone, for example.

In one embodiment, the collected non-magnetic particles are fed directly into the cement manufacturing kiln. The temperature for certain products is high enough to melt the slag without extra grinding steps.

In one embodiment, the iron content of the feed is adjusted by adding by-products instead of adding or other iron corrective materials to the raw mix to optimize the iron content of the cement clinkers. The adjustments can be done by subjecting the by-product to at least one fine grinding step together with the raw feed or it can be added to the cement kiln separately in the form of crushed and collected non-magnetic particles or fine grinded non-magnetic particles. As the by-products have a high iron content, the maximum amount of by-product added to kiln raw material mix may need to be calculated through iron content. If a strong magnet is used in the magnetic separation step after separation crushing, less of the iron oxide minerals remain in the by-product and as a result a larger amount of by-product can be added to the raw mix.

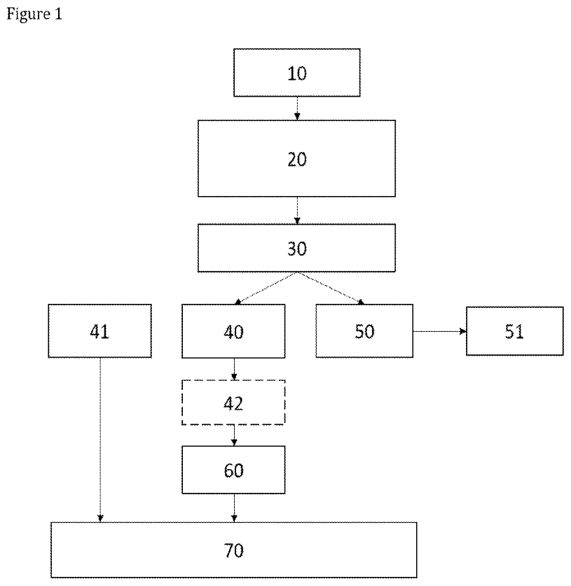

FIG. 1 depicts one possible embodiment of the current method.

Referring to FIG. 1, industrial furnace by-product (10) is subjected to separation crushing (20) to obtain crushed industrial furnace by-product. The crushed industrial furnace by-product is then subjected to magnetic separation (30) to separate non-magnetic particles (40) and magnetic particles (50) from each other. Magnetic particles are recycled (51). Non-magnetic particles are optionally subjected to a classification step (42), after which they are subjected to fine grinding (60) to obtain fine grinded particles. Fine grinded particles are then fed to cement kiln (70) together with raw feed (41).

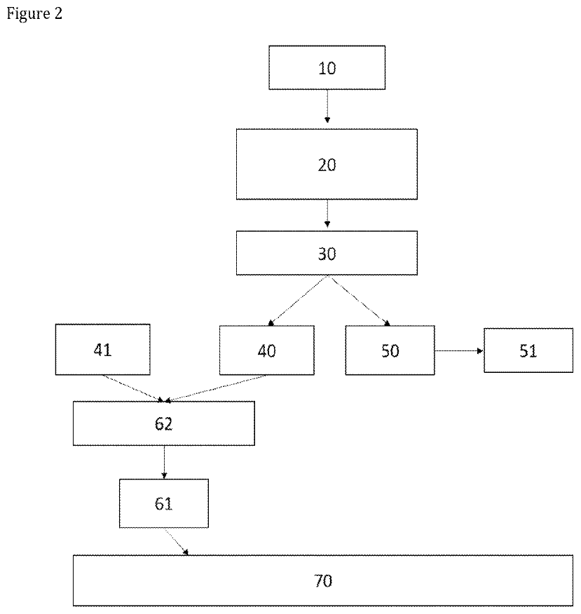

FIG. 2 depicts one possible embodiment of the current method.

Referring to FIG. 2, industrial furnace by-product (10) is subjected to separation crushing (20) to obtain crushed industrial furnace by-product. The crushed industrial by-product is then subjected to magnetic separation step (30) to separate non-magnetic particles (40) and magnetic particles (50). The magnetic particles (50) are recycled (51). The non-magnetic particles (40) are mixed with cement kiln raw feed (41) and are subjected to fine grinding step (62). Fine grinded raw mix (61) is obtained from the grinding step (62) and the collected fine grinded raw mix is fed to a cement kiln (70).

It will be obvious to a person skilled in the art that, as the technology advances, the inventive concept can be implemented in various ways. The invention and its embodiments are not limited to the examples described above but may vary within the scope of the claims.

### EXAMPLE

Pre-crushed steel slag was subjected to the high impact dry crushing performed with the equipment described in patent publication FI128329. Particle size distribution was measured by sieving the crushed material using sieves with different mesh sizes. The particle size distribution was then compared to the particle size distribution of pre-crushed steel slag that was not subjected to high impact dry crushing.

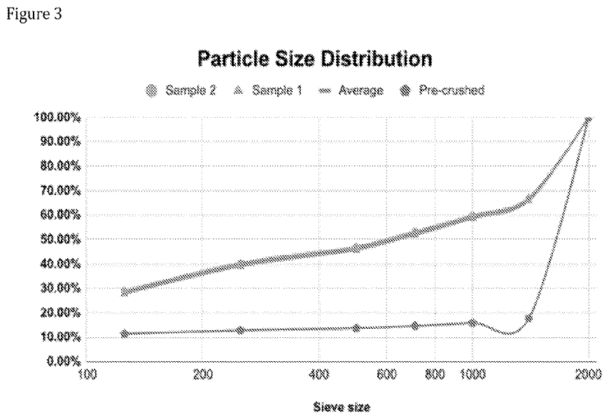

FIG. 3 shows the particle size distribution of Sample 1 and Sample 2, which have been subjected to high impact dry crushing, in comparison to the pre-crushed slag which has not been subjected to high impact dry crushing. The Y axis shows the amount of particles which have passed a certain sieve, and X axis shows the sieve mesh sizes (microns).

As can be seen from the figure, high impact dry crushing results in significantly finer particles in comparison to the particles not subjected to high impact dry crushing.

1-9. (canceled)

10. A method of upgrading industrial furnace by-products, wherein the method comprises:
(a) providing industrial furnace by-product, wherein the industrial furnace by-product is steelmaking slag or incinerated bottom ash,
(b) subjecting the industrial furnace by-product to separation crushing to obtain crushed industrial furnace by-product,
(c) subjecting the crushed industrial furnace by-product to at least one magnetic separation step to separate magnetic particles and non-magnetic particles, and collecting said non-magnetic particles,
(d) optionally subjecting said collected non-magnetic particles to fine grinding to obtain fine grinded particles,
wherein the separation crushing method is high impact dry crushing and wherein high impact dry crushing is performed using a crusher consisting of two rotors rotating in opposite directions,
wherein the high impact dry crushing is performed by feeding the industrial furnace by-product into the middle of an inner rotor and as a result of the centrifugal forces the industrial furnace by-product is ejected to the outer rotor, and as a result the industrial by-product is crushed due to the high impact, after which the industrial by-product is removed through removal holes at the bottom of the mill,
wherein dry crushing means that essentially no water or other liquid is added to the industrial by-product before the high impact dry crushing, and wherein the industrial by-product subjected to the high impact dry crushing has a moisture content from 2 wt % to 15 wt %, preferably from 3 wt % to 8 wt %,
and wherein the particle size of the optionally fine grinded non-magnetic particles is from 10 μm to 100 μm, preferably from 20 μm to 70 μm.

11. The method according to claim 10, wherein the method further comprises one or more classification step(s) followed by one or more separation step(s) to obtain at least one fine particle fraction with particles with the size of 0-3 mm, preferably 1.5-2.5 mm, before step (d).

12. The method according to claim 10, wherein the method includes subjecting said collected non-magnetic particles to fine grinding to obtain fine grinded particles, wherein the fine grinded particles have a particle diameter of 10 μm to 100 μm, preferably from 20 μm to 70 μm.

13. The method according to claim 10, wherein the industrial furnace by-product is steelmaking slag or incinerated bottom ash (IBA), wherein the steelmaking slag is preferably selected from the list consisting of stainless-steel slag, carbon-steel slag, basic oxygen furnace (BOF) slag, electric arc furnace (EAF) slag, ladle furnace (LF) slag, other metallurgical slags and any combination thereof.

14. The method according to claim 10, wherein the method comprises one or more additional non-magnetic metal separation step(s) to separate heavy and light non-magnetics, wherein the non-magnetic separation method is selected from gravitational separation, airflow separation, and any combination thereof.

15. The method according to claim 10, wherein the collected non-magnetic particles are fed to a cement kiln to manufacture cement clinkers.

16. The method according to claim 15, wherein the collected non-magnetic particles are fed to the cement kiln, directly after magnetic separation or after further fine grinding step (d), and wherein the collected non-magnetic particles are used as a complete feed or a part of a feed, and wherein the collected non-magnetic particles are fed to the kiln directly or at a later stage of clinker production.

17. The method according to claim 15, wherein one or more additional ingredients selected from the list consisting of; limestone, gypsum, clay, sand, shale, iron ore, bauxite, fly ash, BF slag, other slags from different metallurgy processes, and any combination thereof.

18. The method according to claim 15, wherein the iron content of the feed is adjusted by adding industrial furnace by-products to the kiln feed.
